(19) United States
(12) Patent Application Publication
(10) Pub. No.: US 2022/0356325 A1
(43) Pub. Date: Nov. 10, 2022

(54) Fluoroelastomer Mixture, Seal Made of Such a Fluoroelastomer Mixture, and Shaft Seal with a Seal Body

(71) Applicant: KACO GmbH + Co. KG, Kirchardt (DE)

(72) Inventors: Detlef Birkhold, Leingarten (DE); Marian Lindenberger, Pleidelsheim (DE)

(21) Appl. No.: 17/729,279

(22) Filed: Apr. 26, 2022

(30) Foreign Application Priority Data
May 4, 2021 (DE) 10 2021 002 431.1

(51) Int. Cl. C08K 3/30; C08K 3/36; C08K 3/22; C08K 3/105; C08L 27/12

(52) U.S. Cl. CPC C08K 3/30; C08K 3/36; C08K 3/22; C08K 3/105; C08L 27/12; C08K 2003/3045; C08K 2003/2227; C08K 2003/2265; C08L 2205/025

(57) ABSTRACT

A fluoroelastomer mixture is provided with a fluoroelastomer that contains at least approximately 50 parts by weight of the fluoroelastomer mixture and further contains one or more mineral fillers in an amount of approximately 2 parts by weight to approximately 80 parts by weight per 100 parts by weight of the fluoroelastomer. The amine-resistant fluoroelastomer is a copolymer of 1,1-difluoroethylene and 2,3,3,3-tetrafluoropropene or a terpolymer of ethylene, tetrafluoroethylene, and perfluoro(methyl vinyl ether). The mineral fillers improve abrasion and/or wear properties of the fluoroelastomer mixture. A seal is provided with the fluoroelastomer mixture. A shaft seal ring is provided that has a seal body provided with the fluoroelastomer mixture.

### BACKGROUND OF THE INVENTION

The invention relates to a fluoroelastomer mixture, a seal made of such a fluoroelastomer mixture, and a shaft seal with a seal body made of a fluoroelastomer mixture.

Due to the electrification in the automotive field, new requirements are imposed on seal systems. As seal systems, for example, radial shaft seals are used whose seal body is comprised of fluoroelastomer polymers. However, they are not resistant to many transmission oils, in particular those that are used in e-mobility. In addition, in this field, the shafts operate at very high rotary speeds, for example, 8,000 RPM and more. Under these boundary conditions, the material of the seals is subject to high requirements that cannot be fulfilled by the conventional fluoroelastomer polymers.

The invention has therefore the object to provide a material that is suitable for seal systems, that can be used in connection with aggressive transmission oils, in particular those used in e-mobility, and is suitable for high peripheral speeds of the shaft.

### SUMMARY OF THE INVENTION

In accordance with the invention, this is achieved with a fluoroelastomer mixture comprising at least approximately 50 parts by weight of an amine-resistant fluoroelastomer and comprising mineral fillers in an amount of approximately 2 parts by weight to approximately 80 parts by weight per 100 parts by weight of fluoroelastomer.

In accordance with the invention, this is achieved with a seal comprised of the fluoroelastomer mixture of the present invention.

In accordance with the invention, this is achieved with a shaft seal with a seal body, wherein the seal body is comprised of a fluoroelastomer mixture of the present invention.

The fluoroelastomer mixture according to the invention is characterized in that it comprises at least 50 parts by weight of an amine-resistant fluoroelastomer as well as mineral fillers in an amount of approximately 2 parts by weight to approximately 80 parts by weight per 100 parts by weight of fluoroelastomer. Such a fluoroelastomer mixture is characterized in that, due to the amine-resistant fluoroelastomer, it comprises a very good media resistance in relation to transmission oils which are in particular used in the field of electromobility (e-mobility). Also, this material can be used at very high rotary speeds of the shaft to be sealed, wherein high rotary speeds are to be understood as speeds of approximately 8,000 RPM and higher. The fillers ensure that the abrasion and wear properties of the fluoroelastomer mixture or of the seals produced therefrom are optimally suitable for the high peripheral speeds of high-speed applications. The abrasion or the wear is minimal even at high peripheral speeds so that the material or the seals produced therefrom have a long service life.

The amine-resistant fluoroelastomer is comprised advantageously of a copolymer of 1,1-difluoroethylene and 2,3,3,3-tetrafluoropropene.

The amine-resistant fluoroelastomer can also be comprised of a terpolymer of ethylene, tetrafluoroethylene, and perfluoro(methyl vinyl ether). Such amine-resistant fluoroelastomers are characterized by a high media resistance.

Advantageously, amine-resistant fluoroelastomers are used whose Mooney viscosity lies between approximately 20 and approximately 65, preferably is approximately 25.

For improving the abrasion and/or wear properties, the fluoroelastomer mixture advantageously contains appropriate mineral fillers that are preferably of a light color. Preferably, approximately 2 to 80 parts by weight of the filler are admixed per 100 parts by weight of fluoroelastomer.

In order to improve the cold flexibility of the fluoroelastomer mixture without affecting the good media resistance and the minimal abrasion/wear, the fluoroelastomer mixture comprises up to approximately 50 parts by weight of a cold-flexible fluoroelastomer per 100 parts by weight of total fluoroelastomer. Total fluoroelastomer is to be understood in this context as the amine-resistant fluoroelastomer plus the cold-flexible fluoroelastomer.

In order to achieve a particularly good processability of the fluoroelastomer, the Mooney viscosity should lie between approximately 20 and approximately 65, preferably be approximately 25.

A good cold flexibility is provided when the cold-flexible fluoroelastomer comprises a glass transition point of approximately −20° C. to approximately −40° C., advantageously approximately −30° C.

Calcium silicate is suitable as a filler for the fluoroelastomer mixture and is contained in an amount of approximately 2 parts by weight to approximately 80 parts by weight per 100 parts by weight of fluoroelastomer in the fluoroelastomer mixture.

In this context, the calcium silicate is advantageously surface-modified. In case of surface-modified calcium silicates, the calcium silicate is modified in that an improved surface binding to the fluoroelastomer is obtained.

An advantageous embodiment results furthermore when the calcium silicate comprises an L:D ratio of approximately 3:1. In this context, L is the length and D is the width of the individual calcium silicate bodies.

Advantageously, the calcium silicate has an average particle size of approximately 2.5 μm to approximately 5 μm. In this way, the calcium silicate can be admixed without problems into the fluoroelastomer mixture.

The proportion of the calcium silicate in the fluoroelastomer mixture lies advantageously at approximately 10 parts by weight to approximately 50 parts by weight per 100 parts by weight of fluoroelastomer. Advantageously, the range lies approximately at 30 parts by weight to approximately 40 parts by weight.

As a further good filler, silica can be used. It is contained in an amount of approximately 2 parts by weight to approximately 80 parts by weight per 100 parts by weight of fluoroelastomer in the fluoroelastomer mixture. Preferably, the amount of silica is approximately 3 to approximately 10 parts by weight, in particular approximately 4 to approximately 8 parts by weight.

It has been found to be particularly advantageous when the silica comprises a specific surface area of approximately 90 m²/g to approximately 250 m²/g.

As a filler, flux-calcinated diatomaceous earth is also suitable in an amount of approximately 2 parts by weight to approximately 80 parts by weight per 100 parts by weight of fluoroelastomer in the fluoroelastomer mixture. Preferably, the amount is approximately 3 to approximately 10 parts by weight, in particular approximately 3 to approximately 7 parts by weight.

Advantageously, diatomaceous earth with an average particle size D50 of approximately 10 μm to approximately 25 μm, preferably 14 μm, is used.

As a filler, furthermore also barium sulfate can be used that is contained in an amount of approximately 2 parts by weight to approximately 80 parts by weight per 100 parts by weight of fluoroelastomer in the fluoroelastomer mixture. Preferably, the amount is in a range of approximately 3 to approximately 10 parts by weight, in particular approximately 3 to approximately 7 parts by weight.

Advantageously, the barium sulfate has an average particle size D50 of approximately 0.3 μm to approximately 25 μm, preferably of approximately 0.7 μm. Such a barium sulfate can be admixed well into the fluoroelastomer mixture.

The fluoroelastomer mixture can be vulcanized for forming a shaped vulcanized elastomer body. In this manner, a seal can be produced that is comprised of such a fluoroelastomer mixture.

The shaped vulcanized elastomer body can also be used in a dynamic seal such as a radial or an axial shaft seal. Such a shaft seal comprises a seal body produced from the fluoroelastomer mixture according to the invention.

The subject matter of the invention not only results from the subject matter of the individual claims but also from all features and specifications disclosed in the drawing and in the description. They are claimed as important to the invention even if they are not subject matter of the claims inasmuch as individually or in combination they are novel in relation to the prior art.

Further features of the invention result from the additional claims and the description.

### BRIEF DESCRIPTION OF THE DRAWING

FIG. 1 shows in axial section a portion of a radial shaft seal ring in accordance with the invention with a seal body that is comprised of a fluoroelastomer mixture according to the invention.

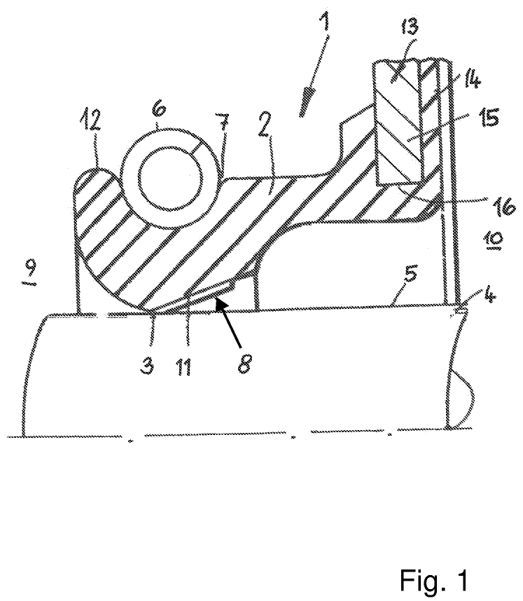

### DESCRIPTION OF THE PREFERRED EMBODIMENTS

The material which will be described in the following is used in particular for seals that can be used in the field of e-mobility. The material is characterized by a good media resistance relative to the aggressive transmission oils that are usually employed in the field of e-mobility and is excellently suitably for very high rotary speeds of the shaft. The use is however not limited to applications in e-mobility. In fact, seals with the advantageous material can be used in any application with aggressive oils.

The seals are in general radial shaft seals which surround the shaft and seal-tightly contact the shaft with at least one seal lip under radial force.

The drawing shows as an example such a radial shaft seal in axial half section. Since such radial shaft seal rings are known in the art, they will not be described in detail here.

The radial shaft seal ring has a seal body 1 which is comprised of the material according to the invention to be described in the following. The seal body 1 comprises a seal lip 2 that is radially movable and contacts seal-tightly with a seal edge 3 the shaft 4 to be sealed under radial force.

The seal edge 3 is contacting under the force of an annular spring 6 seal-tightly a wall surface 5 of the shaft 4. The annular spring 6 engages an annular groove 7 which is located at the exterior side of the seal lip 2 at the level of the seal edge 3.

A return conveying device 8 of a configuration known in the art is extending into the seal edge 3 and ensures that medium to be sealed that has passed underneath the seal edge 3 from the medium side 9 to the air side 10 is returned to the medium side 9. The return conveying device 8 is provided at a cone surface 11 which opens from the seal edge 3 in the direction toward the air side 10.

The annular spring 6 is secured relative to the medium side 9 by a radial projection 12 of the seal lip 2.

The radial force which is acting on the seal edge 3 can be achieved also without use of the annular spring 6 in that the seal lip 2 is designed such that it is elastically deformed in the installed position such that the seal edge 3 is subjected to a radial force.

The seal lip 2 continues into an envelope 14 which covers at least partially the support body 13. In the embodiment, the exterior side of the support body 13 which is facing the air side 10 is covered by the envelope 14. At the exterior side of the support body 13 which is facing the medium side 9, the envelope 14 extends only in the radially inner region.

As is known in the art, the support body 13 comprises an L-shaped cross section. The radially extending part 15 of the support body 13 forms its bottom in which centrally a through opening 16 for the shaft 4 is provided. The rim of the through opening 16 is covered by the envelope 14.

The bottom 15 adjoins a cylindrical wall (not illustrated) extending coaxially to the axis of the radial shaft seal or of the seal body 1 and is covered at least at its outer wall surface at least partially by the envelope 14. With the cylindrical wall, the radial shaft seal is pressed into an installation space of a housing or the like as is known in the art, wherein the envelope 14 which covers this cylindrical wall at the exterior side forms the static seal.

The material for producing the seal body 1 with the seal lip 2 and the envelope 14 is comprised of a fluoroelastomer mixture. It is based on an amine-resistant fluoroelastomer (FKM) that can be comprised of a copolymer of 1,1-difluoroethylene and 2,3,3,3-tetrafluoropropene or of a terpolymer of ethylene, tetrafluoroethylene, and perfluoro(methyl vinyl ether).

In industrial practice (elastomer processing), elastomer recipes or formulations are built always on the basis of 100 parts by weight of polymer. In this way, the sum total of parts by weight that results is always greater than 100. The weight percentages of the individual substances result from the ratio of their parts by weight in relation to the sum total of all parts by weight of the mixture.

The mixture contains at least 50 parts by weight of the copolymer or of the terpolymer.

The amine-resistant fluoroelastomer has advantageously a Mooney viscosity in a range between 20 and 65 Mooney. Advantageously, the Mooney viscosity amounts to 25 Mooney (ML 1+10 @ 121° C.).

Since the shaft 4 in electric drives rotates at high RPM, for example, beginning at approximately 8,000 RPM, very high requirements are placed on abrasion and wear resistance of the material. In order to obtain these high abrasion and wear resistance properties for the high peripheral speeds in high speed applications, mineral fillers are admixed which are present in an amount of between 5 parts by weight and 80 parts by weight per 100 parts by weight of fluoroelastomer.

The fluoroelastomer mixture according to the invention, comprising the amine-resistant fluoroelastomer and the mineral fillers, results in a material that has a very good media resistance in relation to transmission oils combined with a suitability for use at very high RPM, for example, beginning at 8,000 RPM.

The described fluoroelastomer mixture can be vulcanized for forming a shaped vulcanized elastomer product. Such a shaped vulcanized elastomer product is the seal body 1 with the seal lip 2 and the envelope 14 in the described and illustrated radial shaft seal. The manufacture of this seal body 1 is realized as in known in the art.

The shaped vulcanized elastomer product, as described in the embodiment, is used as a dynamic seal, preferably as a seal ring. It can be a radial shaft seal ring but also an axial shaft seal ring.

In order to improve the cold flexibility of the fluoroelastomer mixture, a cold-flexible elastomer rubber can be admixed. Up to 50 parts by weight of the cold-flexible fluoroelastomer per 100 parts by weight of total fluoroelastomer can be used. Total fluoroelastomer is to be understood as the amine-resistant fluoroelastomer plus the cold-flexible fluoroelastomer.

The Mooney viscosity of the cold-flexible fluoroelastomer can amount to between 20 and 65 Mooney (ML 1+10 @ 121° C.), preferably can be approximately 25 Mooney.

Advantageously, the cold-flexible fluoroelastomer has a glass transition point of approximately −20° C. to approximately −40° C. Advantageously, the glass transition point is at −30° C. The glass transition point or the glass transition temperature is to be understood as the temperature at which the cold-flexible fluoroelastomer passes from a liquid or rubber-elastic flexible state into a glassy or hard-elastic brittle state.

In order to improve the good cold flexibility or the low temperature resistance, perfluoro(methyl vinyl ether) can be added to the fluoroelastomer, for example.

As fillers for the fluoroelastomer mixture, for example, surface-modified calcium silicates are conceivable. They are contained in the mixture in an amount of approximately 5 parts by weight to 60 parts by weight per 100 parts by weight of fluoroelastomer. Advantageously, the L:D ratio (length to width of the silicates) of the calcium silicate is at approximately 3 to 1. The individual silicates have advantageously an average particle size D50. D50 means that 50 percent of the particles of calcium silicate are smaller than the indicated value. The particle size is advantageously in a range of approximately 2.5 μm to 5 μm.

Preferred amounts of the surface-modified calcium silicates lie at approximately 10 parts by weight to approximately 50 parts by weight per 100 parts by weight of fluoroelastomer. Advantageously, the amount of the calcium silicate is between approximately 30 parts by weight and approximately 40 parts by weight per 100 parts by weight of fluoroelastomer.

A further possibility of mineral fillers to be admixed to the fluoroelastomer mixture are silica fillers. They are added in an amount of approximately 2 parts by weight to approximately 20 parts by weight per 100 parts by weight of fluoroelastomer. Advantageously, the silica fillers have a specific surface area between approximately 90 m²/g to approximately 250 m²/g. Preferred amounts lie between approximately 3 parts by weight and 10 parts by weight per 100 parts by weight of fluoroelastomer. A particularly preferred range lies at 4 to 8 parts by weight per 100 parts by weight of fluoroelastomer.

As mineral filler, also flux-calcinated diatomaceous earth is conceivable. It can be contained in an amount of approximately 2 parts by weight to approximately 20 parts by weight per 100 parts by weight of fluoroelastomer. This silicate has an average particle size D50 of 10 μm to 25 μm. Preferably, the particle size is approximately 14 μm.

Preferably, the amount of flux-calcinated diatomaceous earth is in the range of 3 parts by weight to 10 parts by weight per 10 parts by weight of fluoroelastomer. A particularly advantageous mixture is provided when the amount of flux-calcinated diatomaceous earth is in a range between approximately 3 parts by weight to approximately 7 parts by weight per 100 parts by weight of fluoroelastomer.

A further possibility of a filler is barium sulfate. It can be added in an amount of approximately 2 parts by weight to approximately 80 parts by weight per 100 parts by weight of fluoroelastomer. An advantageous range lies between approximately 3 parts by weight and approximately 10 parts by weight, in particular at approximately 3 parts by weight to approximately 7 parts by weight.

Barium sulfate has advantageously a particle size D50 of approximately 0.3 μm to approximately 25 μm, preferably of approximately 0.7 μm.

In the described fluoroelastomer mixtures, organic peroxides in a range of approximately 0.5 to approximately 3 parts by weight per 100 parts by weight of fluoroelastomer are used for cross-linking.

In the following, two composition examples of the fluoroelastomer mixture are disclosed. The employed components are commercially available.

### Example 1

amine-resistant FKM (DAI EL GBR 6002, manufactured by Daikin Chemicals, Mooney viscosity ML 1+10 @ 121° C. 25): 100 parts by weight;
surface-modified calcium silicate (Tremin 283-60 EST, manufactured by Quarzwerke): 38 parts by weight
silica (Aerosil R972, manufactured by Evonik): 7 parts by weight
flux-calcinated diatomaceous earth (Celite 499, manufactured by Lehmann und Voss): 6 parts by weight
TAIC (manufactured by Kettlitz): 1.5 parts by weight
peroxide (Peroxan BIB-1, manufactured by Pergan): 1 part by weight

### Example 2

amine-resistant FKM (DAI EL GBR 6002, manufactured by Daikin Chemicals, Mooney viscosity ML 1+10 @ 121° C. 25): 60 parts by weight;
cold-flexible FKM (DAI EL LT 304, manufactured by Daikin Chemicals, Mooney viscosity ML 1+10 @ 121° C. 25): 40 parts by weight;
surface-modified calcium silicate (Tremin 283-600 EST, manufactured by Quarzwerke): 38 parts by weight;
silica (Aerosil R972, manufactured by Evonik): 7 parts by weight;
flux-calcinated diatomaceous earth (Celite 499, manufactured by Lehmann und Voss): 6 parts by weight
TAIC (produced by Kettlitz): 1.5 parts by weight
peroxide (Peroxan BIB-1, manufactured by Pergan): 1 part by weight.

For the amine-resistant fluoroelastomer (FKM), the indicated Mooney viscosity ML 1+10 @ 121° C. has the following meaning:

ML=large test rotor (according to Mooney standard 53523)
1=preheating time in minutes
10=testing time in minutes
121° C.=testing temperature in ° C.

The Mooney viscosity is determined by means of a Mooney viscosity test for determining the properties of elastomer materials that are not vulcanized. The sample is preheated for a predetermined amount of time and then loaded at a constant shearing speed. The Mooney viscosity is recorded starting at the end of this deformation phase.

For manufacturing the fluoroelastomer mixture, an elastomer rubber internal mixer is used. The entire quantity of the fluoroelastomer is introduced into the inner mixer. After 45 seconds of mastication, the entire quantity of the fillers is added. The fluoroelastomer and the fillers are mixed for 60 seconds. Subsequently, the ram of the internal mixer is cleaned and subsequently the mixture is mixed for additional 60 minutes. Then, the peroxide and TAIC (triallyl isocyanurate) are added and mixing is continued for additional 45 seconds. The ram of the internal mixer is cleaned again and subsequently the mixture is mixed for additional 45 seconds. Subsequently, the fluoroelastomer mixture is ejected from the internal mixer and supplied to an elastomer rolling mill. Here, the fluoroelastomer mixture is rolled for approximately 2 to 3 minutes and subsequently cut into strips of the desired dimension.

Should a temperature of more than 120° C. occur during the entire mixing process, the mixture is immediately ejected.

TAIC serves as a co-agent for peroxide cross-linking and provides good physical values. Particularly positive is that compression set and strength of the fluoroelastomer mixture are improved. The mixing ratio of TAIC and peroxide can lie in a range of 1.5:1 to 2:1, for example.

The specification incorporates by reference the entire disclosure of German priority document 10 2021 002 431.1 having a filing date of May 4, 2021.

While specific embodiments of the invention have been shown and described in detail to illustrate the inventive principles, it will be understood that the invention may be embodied otherwise without departing from such principles.

What is claimed is:

1. A fluoroelastomer mixture comprising:
a fluoroelastomer comprising an amine-resistant fluoroelastomer, wherein the amine-resistant fluoroelastomer amounts to at least approximately 50 parts by weight of the fluoroelastomer mixture;
one or more mineral fillers in an amount of approximately 2 parts by weight to approximately 80 parts by weight per 100 parts by weight of the fluoroelastomer.

2. The fluoroelastomer mixture according to claim 1, wherein the amine-resistant fluoroelastomer is comprised of a copolymer of 1,1-difluoroethylene and 2,3,3,3-tetrafluoropropene or of a terpolymer of ethylene, tetrafluoroethylene, and perfluoro(methyl vinyl ether).

3. The fluoroelastomer mixture according to claim 1, wherein the amine-resistant fluoroelastomer comprises a Mooney viscosity between approximately 20 and approximately 65.

4. The fluoroelastomer mixture according to claim 1, wherein the one or more mineral fillers are configured to improve abrasion and/or wear properties of the fluoroelastomer mixture.

5. The fluoroelastomer mixture according to claim 1, wherein the fluoroelastomer further comprises up to approximately 50 parts by weight of a cold-flexible fluoroelastomer per 100 parts by weight of a sum total of the amine-resistant fluoroelastomer and the cold-flexible fluoroelastomer.

6. The fluoroelastomer mixture according to claim 5, wherein the cold-flexible fluoroelastomer has a Mooney viscosity between approximately 20 and approximately 65.

7. The fluoroelastomer mixture according to claim 5, wherein the cold-resistant fluoroelastomer has a glass transition point of approximately −20° C. to approximately −40° C.

8. The fluoroelastomer mixture according to claim 1, wherein the one or more mineral fillers include calcium silicate in an amount of approximately 2 parts by weight to approximately 80 parts by weight per 100 parts by weight of the fluoroelastomer.

9. The fluoroelastomer mixture according to claim 8, wherein the calcium silicate is surface-modified.

10. The fluoroelastomer mixture according to claim 8, wherein the calcium silicate has a length to width ratio of approximately 3:1.

11. The fluoroelastomer mixture according to claim 8, wherein the calcium silicate has an average particle size of approximately 2.5 μm to approximately 5 μm.

12. The fluoroelastomer mixture according to claim 8, wherein the amount of the calcium silicate is approximately 10 parts by weight to approximately 50 parts by weight per 100 parts by weight of the fluoroelastomer.

13. The fluoroelastomer mixture according to claim 1, wherein the one or more mineral fillers include silica in an amount of approximately 2 parts by weight to approximately 80 parts by weight per 100 parts by weight of the fluoroelastomer.

14. The fluoroelastomer mixture according to claim 13, wherein the silica has a specific surface area of approximately 90 m²/g to approximately 250 m²/g.

15. The fluoroelastomer mixture according to claim 1, wherein the one or more mineral fillers include flux-calcinated diatomaceous earth in an amount of approximately 2 parts by weight to approximately 80 parts by weight per 100 parts by weight of the fluoroelastomer.

16. The fluoroelastomer mixture according to claim 15, wherein the flux-calcinated diatomaceous earth has an average particle size D50 of approximately 10 μm to approximately 25 μm.

17. The fluoroelastomer mixture according to claim 1, wherein the one or more mineral fillers include barium sulfate in an amount of approximately 2 parts by weight to approximately 80 parts by weight per 100 parts by weight of the fluoroelastomer.

18. The fluoroelastomer mixture according to claim 17, wherein the barium sulfate has an average particle size D50 of approximately 0.3 μm to approximately 25 μm.

19. A seal comprised of a fluoroelastomer mixture according to claim 1.

20. A shaft seal ring with a seal body comprised of a fluoroelastomer mixture according to claim 1.
